(19) United States
(12) Patent Application Publication
(10) Pub. No.: US 2010/0084081 A1
(43) Pub. Date: Apr. 8, 2010

(54) Method for Fabricating Organic Optoelectronic Multi-Layer Devices

(75) Inventors: Chih-Wei Chu, Taipei City (TW); Zhong-Yo Ho, St. Lujhou City (TW)

Correspondence Address: COHEN, PONTANI, LIEBERMAN & PAVANE LLP, 551 FIFTH AVENUE, SUITE 1210, NEW YORK, NY, 10176, US

(73) Assignee: Academia Sinica, Nankang Teipei (TW)

(21) Appl. No.: 12/536,718

(22) Filed: Aug. 6, 2009

Related U.S. Application Data
(60) Provisional application No. 61/188,065, filed on Aug. 6, 2008.

(51) Int. Cl. B32B 37/02

(52) U.S. Cl. 156/230

(57) ABSTRACT

A method for fabricating organic optoelectronics multi-layer devices is disclosed. A polydimethylsiloxane (PDMS) surface is pretreated with an organic solvent and used to directly form a uniform optoelectrical thin-film from organic solution by spin coating. The optoelectrical thin-film films that are formed on the PDMS surface are easily transferable to any substrate by a slight, externally applied force for providing conformal contact with a target substrate and thermal annealing, depending on the polymers to be transferred. Pretreatment of the PDMS surface with the organic solvent combined with a dry transfer process provides an easier way to cascade polymer architecture fabrication. In addition, the method increases the performance of various types of organic photo electronics, and permits an extension of the types of research that can be performed in the field of photo electronics.

### CROSS-REFERENCE TO RELATED APPLICATIONS

This application claims priority from U.S. Provisional Application Ser. No. 61/188,065 filed Aug. 6, 2008, the content of which is hereby incorporated by reference in its entirety.

### BACKGROUND OF THE INVENTION

1. Field of the Invention

The present invention generally relates to the field of optoelectronics and, more particularly, to a method for fabricating organic optoelectronics multi-layer devices.

2. Description of the Related Art

A considerable level of research in organic thin-film electronics has led to the creation of devices, such as organic transistors, solar cells and light emitting diodes. The performance of these devices is comparatively lower than that of inorganic based devices due to limitations associated with optical absorption and the migration of strongly bound photo generated excitons. However, organic electronics still provide an advantage with respect to cost of fabrication, flexible substrates, reliability, and are also environmentally friendly.

There is a great desire to improve the performance of these devices by providing new molecular synthesis and structural designs, which has rapidly evolved over the past few years.

Despite the essential properties of materials utilized, which are the most important factors for determining the performance of these devices, the cascade architecture is another primary parameter that affects the performance of organic electronics, particularly for light emitting diodes and solar cells. Generally, it is possible to perform a time-consuming thermal vacuum deposition for small molecules to fulfill the cascade structure via layer-by-layer deposition. However, there are problems encountered by the conventional spin coating process for polymer materials, which need to be solved for such multilayer structures because of the dissolution of the previous layer by an organic solvent. At present, there is no widespread and reliable method with which to fabricate arbitrary, all-solution-processed multilayer polymer electronics. The conventional methods for fabricating multilayer polymer electronics to eliminate the dissolution problems associated with the preceding layer caused by successive solution in conventional spin coating or ink-jet printing methods are restricted to particular polymers and solvents.

Moreover, organic semiconductors (OSs) have received a great deal of attention from both academic and industrial laboratories because of their processing advantages and their mechanical properties. These OSs can be easily solution processed. Consequently, such OSs present a promising candidate for high throughput, low-cost and large area fabrication of optoelectronics, such as light emitting diodes (LEDs) thin-film transistors (TFTs) and solar cells (SCs).

Considerable progress has been made in designing solution-processed organic semiconductors; however, the performance of the devices is somehow restricted by their relatively poor carrier transfer properties and large energy bandgaps, which result in poor performance compared to most of their inorganic counterparts. While the inherent material properties of these OSs are important in achieving the desired device output, the device structure is another primary factor for achieving efficient devices. For example, time-consuming thermal vacuum deposition for small molecules could fulfill the multilayer and tandem structure via layer-by-layer deposition. Alternatively, in order to reduce the time scale of the manufacturing process, solution processing of the active layer components of the device could be utilized. However, dissolution of the initial layer by the subsequent layers during spin coating acts as a barrier to the realization of multilayer spin coating films. Earlier researchers have employed different approaches to overcome such issues that include utilization of cross-linking polymers, use of different solvents for subsequent layers or through insertion of intermediate buffer layers to protect the preceding layers. A drawback associated with the use of cross-linking polymers is that the performance of the polymers is decreased after the cross-linking process.

A disadvantage associated with the use of different solvents is that only a limited combination of materials and solvents can be chosen. Therefore, besides these recent advances, there is a great demand for fabricating innovative multilayer structures through a simple and reliable technique that can be utilized for both single and multilayer films.

The polydimethylsiloxane (PDMS) lamination process is a recently developed technique that provides some use for multilayer structure fabrication that is commonly performed in polymer thin-film transistors (TFTs). This technique eliminates the dissolution problem. However, unwanted molecules used for transferring the polymer films from the silicon wafer to the PDMS contaminate the original device materials. As a result, a decrease in the performance of the device occurs.

For example, the relatively new PDMS lamination process has been used in the area of organic electronics for connecting metal to organics, organics to metal, and organics to organics. In other implementations, artisans have modified the PDMS lamination process for transfer printing and have fabricated bi-layer polymer LEDs and SCs. Here, a sacrificial layer cast on silicon wafer was used, thus allowing the PDMS to attach to the solid objects on the silicon wafer modified to include a sacrificial layer. Although this method prevents the dissolution problem, this method is overly complex and the residual of the sacrificial layer contaminates the interface between two organic layers, resulting in a decrease in device performance. In order to overcome these drawbacks, other artisans have modified the surface of the PDMS by plasma treatment such that the polymer films are able to cast on the PDMS directly. However, this destructive physical treatment procedure not only complicates the entire process but also causes extensive damage to the surface structure of the PDMS due to the high power plasma treatment. Consequently, the morphology of the transferred polymer films is influenced, which leads to poor solar cell performance.

### SUMMARY OF THE INVENTION

Disclosed is a method that provides a way to universally improve polymer film fabrication via a polydimethylsiloxane (PDMS) transferring process. In comparison to traditional inorganic optoelectronics, organic based optoelectronics offer unique advantages, such as reduced cost, flexibility, reduced weight, and an improved eco-process. A cascade architecture layer is constructed layer-by-layer via a PDMS polymer thin-film transference. The method eliminates the need for any unwanted molecules and the damage that they can potentially cause on bottom films, which results from the preceding film during the transfer process. As a result, a stable, fast and reproducible way is achieved to fabricate organic optoelectronic multi-layer devices.

The method comprises initially treating the surface of a PDMS stamp with at least one organic solvent, such as acetone, toluene or cholorobenzene, based on the solvent used for the polymer solution. Here, the organic solvents not only clean the PDMS surface, but also eliminate any stress on the PDMS surface caused by the stamp formation process. More importantly, however, the homogeneity of the polymer film around the PDMS surface must be maintained by residual solvent vapor.

After treatment of the PDMS stamp surface with the organic solvent, a semi-conducting polymer film is directly spun onto the PDMS surface. The conveying step is performed using an external force to create a conformal contact, along with thermal annealing at or near the glass transition temperature of the transferred polymer and the bottom layer materials on a hot plate for a predetermined period of time. Preferably, the extended period of time is from one to two minutes. After peeling away the PDMS stamps, the semi-conducting polymer film is completely transferred to a target substrate, such as glass or polyethylene terephtalate (PET), and the PDMS stamps thus become reusable for another batch of film fabrication.

A modified printing method is provided that increases the affinity of PDMS for organic solvents via a non-destructive solvent treatment. The disclosed method eliminates the necessity for a plasma treatment, and any possible damage to the PDMS surface such that full control over the chemical composition and film thickness of each layer is provided.

The method permits improvement of the efficiency of organic optoelectronics, as well as diversification of the fabrication of organic optoelectronics. The disclosed method surpasses inorganic optoelectronics by permitting the further development of high efficiency organic materials. The disclosed method is implemented in a non-vacuum environment, and the multi-layer structure can be achieved by transferring the polymer from the PDMS stamp. The method eliminates the necessity to include an extra supporting layer for film transfers from the PDMS surface to the target surface. As a result, PDMS stamps are achieved that can be reused for tens of layers. The method also permits the easy formation of a large coverage area having a uniform polymer film on the PDMS stamp surface. Moreover, an optimum contact between the preceding layer and the successive layer can be achieved. In addition, it becomes possible to fabricate the uniform polymer film on top of the PDMS stamp without any extra treatment of the PDMS stamp, such as UV-ozone and plasma treatments. The multilayer polymer structure also has use in photovoltaic applications.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a flow diagram of the film transfer in accordance with the method of the invention;

FIGS. 2(a) thru 2(e) is an illustration of the film transfer in accordance with an alternative embodiment;

FIG. 3 is an illustration of an image of a PDMS cast with P3HT after performing the disclosed methods in accordance with the contemplated embodiments;

FIG. 4(a) is an illustration of Atomic Force Microscopy (AFM) images obtained from P3HT:PCBM (1:1) solution in chloroform spun on to a PDMS stamp surface;

FIG. 4(b) is an illustration of a PDMS stamp surface after film transference is performed;

FIG. 4(c) is an illustration of P3HT:PCBM film on a glass obtained by PDMS transference;

FIG. 4(d) is an illustration of P3HT:PCBM film on a glass substrate obtained by spin coating;

FIG. 5(a) is an illustration of AFM images of a P3HT cast from chloroform onto a PDMS stamp after completion of the disclosed methods of the contemplated embodiments;

FIG. 5(b) is an illustration of the PDMS stamp surface morphology after completion of the contemplated embodiments of the disclosed methods;

FIG. 6 is a cross-sectional illustration of a Scanning Electron Microscopy (SEM) image of a glass substrate with P3HT disposed on its top and P3HT:PCBM (1:1) as the second layer;

FIG. 7 is a graphical plot illustrating a comparison of cell performance under AM 1.5G (100 mWcm⁻²) for single, double and triple active layers of P3HT:PCBM;

FIG. 8(a) is a graphical plot of normalized photoluminescence spectra of three polyfluorene derivatives excited at 400 nm;

FIG. 8(b) is a graphical plot of the absorbance and PL quenching results for P3HT, PCBM, single films and double film fabricated from the PDMS stamping process in accordance with the contemplated embodiments of the disclosed methods;

FIG. 9(a) is an illustration of the cell performance tested under AM 1.5 G (100 mW cm⁻²) for the BHJ SCs with different numbers of active layer based on P3HT:PCBM (1:1 in wt %) fabricated in accordance with the contemplated embodiments of the disclosed methods;

FIG. 9(b) is an illustration of the cell performance tested under AM 1.5 G (100 mW cm⁻²) for the inverted bi-layer structure at various annealing temperatures; and

FIG. 10 is a graphical plot of the absorbance and PL quenching results for bi-layer and BHJ SCs fabricated in accordance with the contemplated embodiments of the disclosed methods.

### DETAILED DESCRIPTION OF THE EXEMPLARY EMBODIMENTS

Disclosed is a method that provides a way to universally improve polymer film fabrication via a polydimethylsiloxane (PDMS) transferring process. A cascade architecture layer is constructed layer-by-layer via a PDMS polymer thin-film transference. The method eliminates the need for any unwanted molecules and the damage that they can potentially cause on bottom films, which results from the preceding film during the transferring process. As a result, a stable, fast and reproducible way is achieved to fabricate organic optoelectronic multi-layer devices.

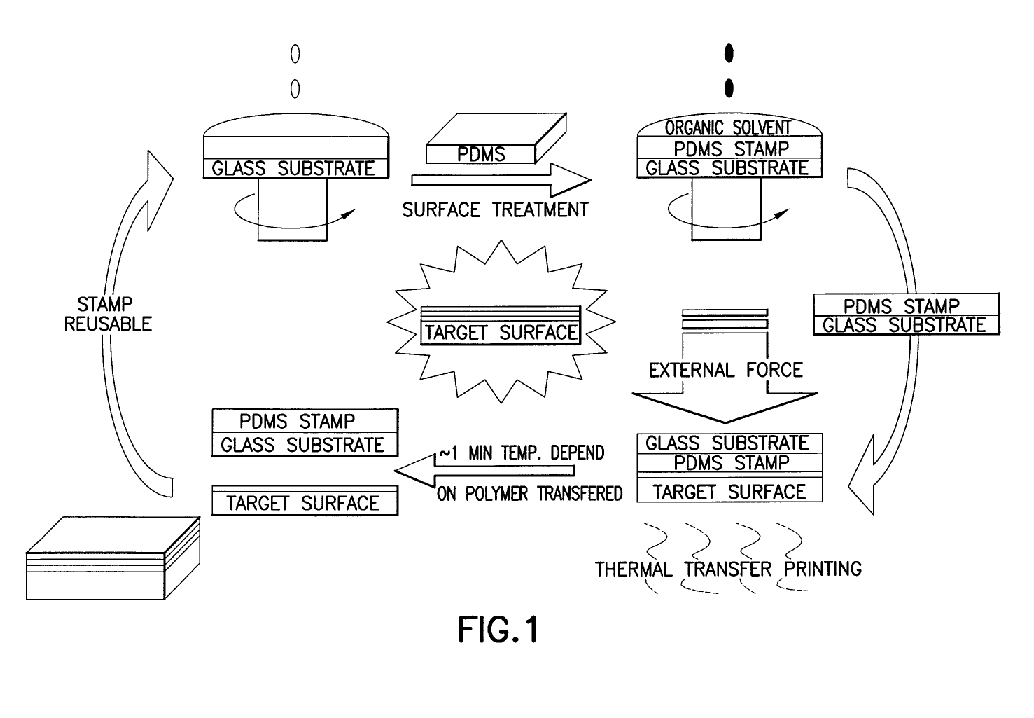

FIG. 1 is a flow diagram of a film transfer in accordance with the method of the invention. In general, the method comprises treating a PDMS surface comprising a silicon wafer fixed on a glass substrate with organic solvents by spinning. Next, the transferred film from an organic solvent is spun directly on the PDMS stamp. An external force and thermal annealing are simultaneously used to transfer the film spun on the PDMS surface to a target substrate. After transferring the film spun on the PDMS, it becomes possible to reuse the PDMS stamp for the successive film conveying.

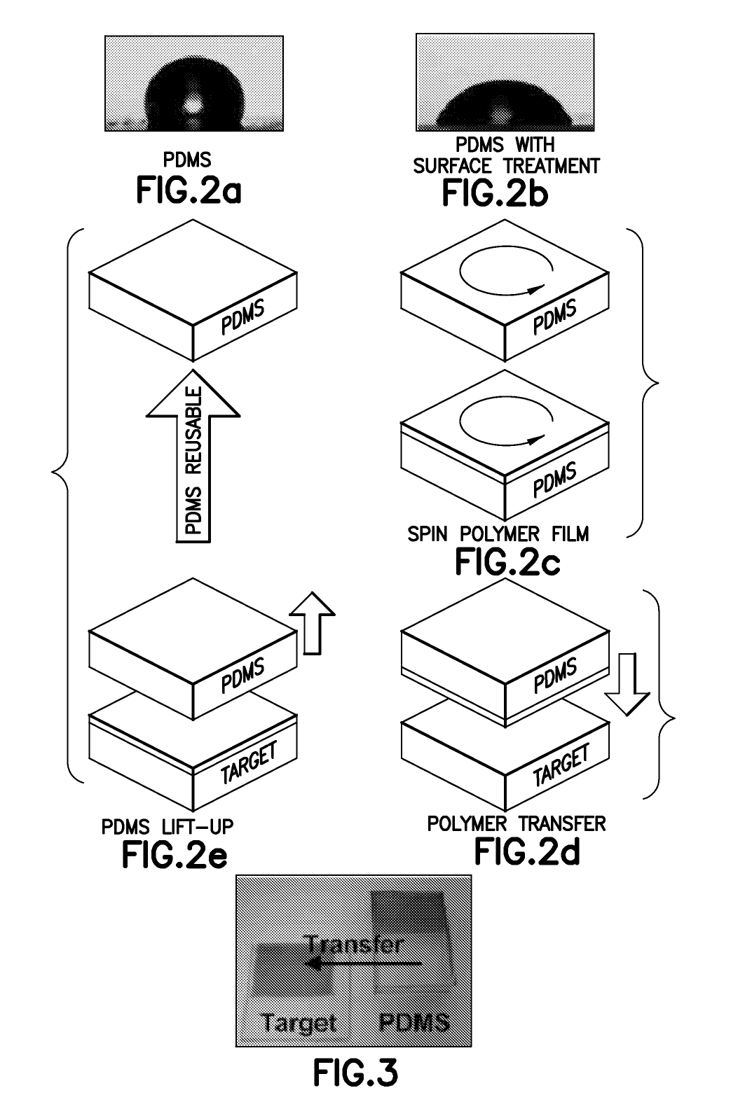

FIGS. 2(a) through 2(e) is an illustration of the film transfer in accordance with an alternative embodiment. Here, the method comprises initially treating the surface of a PDMS stamp with at least one organic solvent, such as acetone, toluene or cholorobenzene, based on the solvent used for dissolving the polymer (see FIG. 2(b)). The organic solvent not only cleans the PDMS surface, but also eliminates any stress on the PDMS surface caused by the stamp formation process. More importantly, however, the homogeneity of the polymer film around the PDMS surface must be maintained by residual solvent vapor treatment. That is, it is critical to maintain homogeneity of the polymer film with residual solvent vapor around PDMS surface. The residual solvent vapor can change the surface energy of PDMS by carefully controlling the spin rate, which decreases the chloroform contact angle significantly as shown in FIGS. 2(a) and 2(b).

After treatment of the PDMS stamp surface with the organic solvent, a semi-conducting polymer film is directly spun onto the PDMS surface. Thus, after solvent treatment it becomes possible to directly spin the polymer film onto the PDMS surface (see FIG. 2(c)). The conveying step is performed using an external force to create a conformal contact, along with thermal annealing on a hot plate for a predetermined time period, at or near the glass transition temperature of the transferred polymer and the bottom layer materials. That is, the stamping process is performed by attaching the polymer film coated on the PDMS stamp onto the target surface under thermal and physical driving forces (see FIG. 2(d)). It should be noted that near the glass transition temperature, the transfer of films from the PDMS to the target surface occurs effectively and, hence, the stamping is performed at a preferred temperature of 120° C. Preferably, the predetermined time period is from one to two minutes.

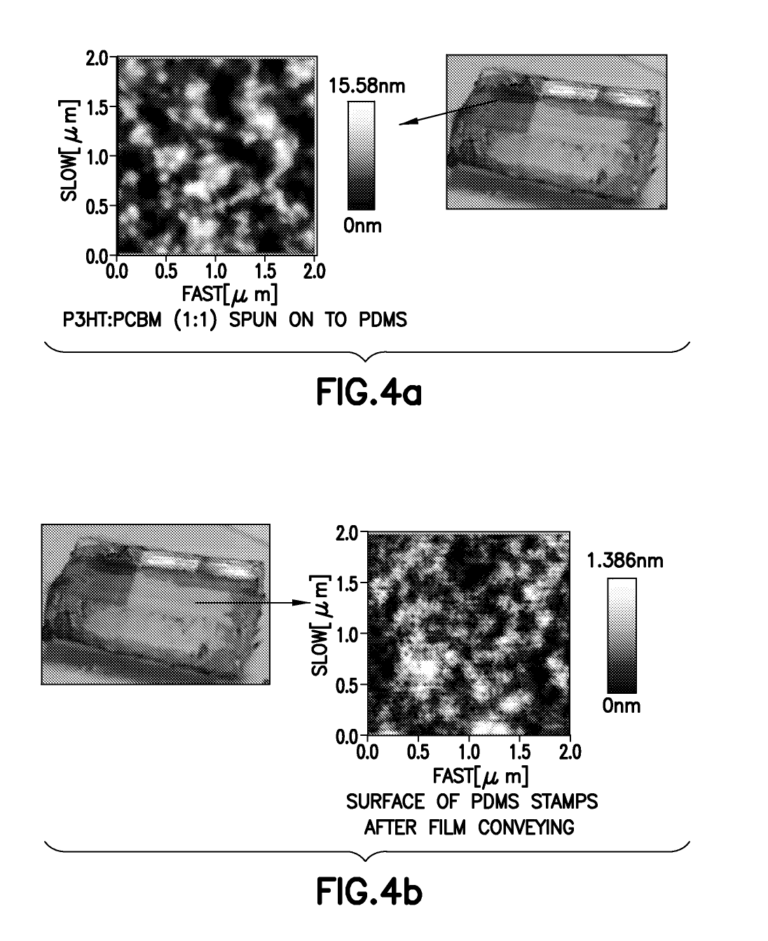

After peeling away the PDMS stamp, the semi-conducting polymer film is completely transferred to the target substrate, such as glass or polyethylene terephtalate (PET), and the PDMS stamps thus become reusable for the next batch of film fabrication. Consequently, as shown in FIG. 2(a), after transferring the polymer film, the PDMS stamps are reusable for another batch of film transfer in accordance with the disclosed method. FIG. 3 is an illustration of an image of a PDMS cast with P3HT after performing the disclosed stamping method in accordance with the contemplated embodiments.

In general, the stamping process depends on the external force applied and the temperature at which the process takes place. It is thus necessary to inspect the conditions for the transference from the PDMS to the target substrate, i.e., the external force and temperature, in order to successfully transfer any films onto PDMS stamps. The condition for the transference is actually determined by the difference in adhesion between the polymer film, the target substrate and the PDMS surface. The sticking coefficient between the polymer film, the target substrate, and PDMS surface determines the magnitude of force required for the stamping in accordance with the disclosed method. Here, an excessive external force should not be exerted, because the film transferred onto the target surface may become damaged from an inevitable shear stress caused by the contact with the PDMS stamp. Accordingly, the external force applied during the stamping process is preferably maintained as low as 4.35×104 Pa to prevent shear stress.

In addition, the stamping temperature is important because the compatibility of the former layer on the target substrate with the subsequent layer from the PDMS would be better if the entanglement of the polymers were to occur at the interface. That is, the stamping temperature is the other important issue in the method that provides a driving force for polymer transfer. At the approximate glass transition temperature of the polymer, it is anticipated that the defect at the interface would be less than the defect that would occur during the stamping process at room temperature. That is, at or around the glass transition temperature of polymer, the existence of fewer voids at the interface is noted than for stamping that is performed at room temperature.

Exemplary planar polydimethylsiloxane (PDMS) stamps (i.e., solar cells) for the disclosed transfer method were fabricated by thoroughly mixing an oligomer or silicone elastomer, such as SYLGARD® 184A, with a curing agent on silicon substrates. The preferred ratio of the elastomer to the curing agent is 10:1 by volume. After completion of the mixing, the mixed substance is poured onto a silicon wafer to achieve a smooth surface stamp, and is then placed in a vacuum for an extended time-period, such as one hour, in order to remove the air bubbles. After removing all bubbles by degassing in the vacuum, the PDMS stamps with silicon substrate are cured at 70° C. in an oven for an extended number of hours, such as 3-4 hours. The cured PDMS is then subsequently removed from the mould and cut into the appropriate dimensions. For example, the PDMS stamps are peeled off from the silicon substrate for the film stamping process.

The bulk heterojunction (BHJ) SCs utilized comprise a layer of poly(3-hexylthiophene):[6,6]-phenyl C61-butyric acid methyl ester (P3HT:PCBM) blend thin-film sandwiched between transparent anode indium tin oxide (ITO) glass and metal cathode. Before device fabrication, the ITO glass (1.5×1.5 cm₂) is ultrasonically cleaned in detergent, de-ionized water, acetone and isopropyl alcohol before the deposition.

After routine solvent cleaning, the substrate is subjected to an UV ozone treatment for a predetermined time period, such as 15 minutes. A modified ITO surface is obtained by spin-coating by spin coating a layer of poly(3,4-ethylene-dioxythiophene):polystyrenesulfonate (PEDOT:PSS) or a layer of poly(ethylene dioxythiophene):polystyrenesulfonate (PEDOT:PSS) (˜30 nm) at a predefined rate of revolution, such as 4000 rpm, and annealed at a specific temperature and an extended time period, such as 120° C. and 1 hour, respectively. Subsequently, the active layer of P3HT:PCBM (1:1 w/w) is transferred from the PDMS stamp onto the PEDOT:PSS modified ITO surface. Preferably, the entire transfer process is performed in a nitrogen-filled glove box. Finally, 30 and 100 nm thick calcium and aluminum are thermally evaporated under vacuum at a pressure below 6×10×6⁻⁶ Torr through a shadowmask. Here, the active area of the device is 0.12 cm². For an inverted solar cell based on P3HT and PCBM, a caesium carbonate (Cs₂CO₃) electron injection layer is cast on the ITO substrate that is prepared as described previously. A PCBM layer is then spin cast from chloroform and subsequently the P3HT was transferred from the PDMS stamp.

The active layer is subsequently spin coated on the PDMS stamps from a mixed blend of poly(3-hexylthiophene) (P3HT) and [6,6]-phenyl C61-butyric acid methyl ester (PCBM). Preferably, the ratio of P3HT to PCBM is approximately 1:1 by wt %. Here, the solvent used for the blend preparation is chloroform. After realization of the stamping process, the device structure is completed by cathode deposition, which involves a bilayer of Ca (30 nm) and Al (70 nm). That is, the thicknesses of PCBM and P3HT are controlled at 40 and 100 nm cast from chloroform. Upon completion of the transfer process, the target sample (ITO/Cs₂CO₃/PCBM/P3HT) is transferred to a vacuum chamber to deposit the anode electrodes for the SCs, which consist of V₂O₅ (10 nm) and Al (70 nm).

In accordance with the present exemplary embodiment, the bilayer is deposited under high vacuum at a fixed base pressure, such as approximately 10⁻⁶ Torr. The J-V characteristics were measured using a semiconductor parameter analyzer, such as a HP4156A manufactured by the Hewlett Packard Company. Here, the characteristics are measured under a simulated solar radiation, such as AM 1.5G, 100 mWcm⁻². Moreover, the measurements are performed at room temperature in the glove box filled with nitrogen. That is, solar cell testing is performed inside the glove box under simulated AM 1.5 G irradiation (100 W/cm2) using a Xenon lamp based solar simulator, such as a Thermal Oriel at 1000 W. The absorption and photoluminescence (PL) spectra were obtained from a Jasco-V-670 UV-visible spectrophotometer and a Hitachi F-4500, respectively. Images of the surface morphology and cross sections of thin-films are obtained using atomic force microscopy (AFM) digital instrument.

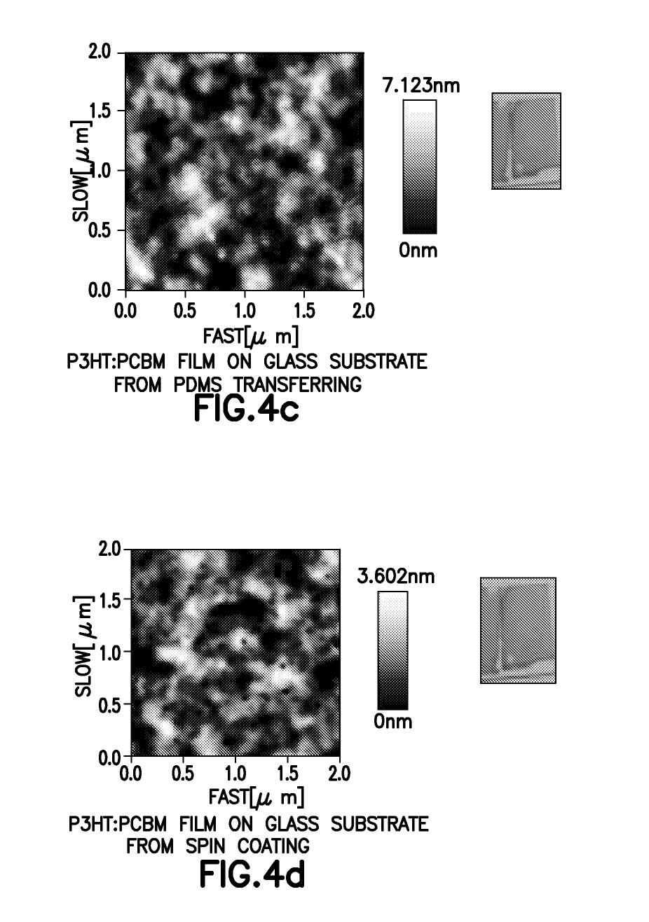

The present inventors note that it is important to determine the possible chemical or mechanical damage that could occur after the simultaneous application of external force and thermal annealing during the transfer method of the invention. That is, the method of stamping that is implemented involves the simultaneous application of external force and heat treatment. As a result, there is a possibility of mechanical damage occurring to the “active layer” as well as the PDMS stamp. Accordingly, Atomic Force Microscopy (AFM) is implemented to measure the surface morphology of the PDMS stamp before and after performance of the transference. FIGS. 4(a) thru 4(d) show such AFM images obtained from P3HT:PCBM (in 1:1 weight ratio) solution in chloroform spun onto PDMS stamps (FIG. 4(a)), transferred to a glass substrate (FIG. 4(c)), the surface of the PDMS stamps after transference (FIG. 4(b)), and films made by spin coating onto the glass substrate directly from the same solution (FIG. 4(d)).

As appreciated from the AFM images shown in FIGS. 4(a) through 4(d), it is clearly visible that the film spun on the PDMS (see FIG. 4(a)) surface is transferred thoroughly (see FIG. 4(b)) to the target substrate shown in FIG. 4(c), where the PDMS stamp is also shown in the inset between the figures. While the right hand side of the surface is the surface of the PDMS stamp after transferring, a film that is not in contact with the target surface is shown on the left hand side of these figures. The disclosed method thus demonstrates that patterning is easily and advantageously accomplished.

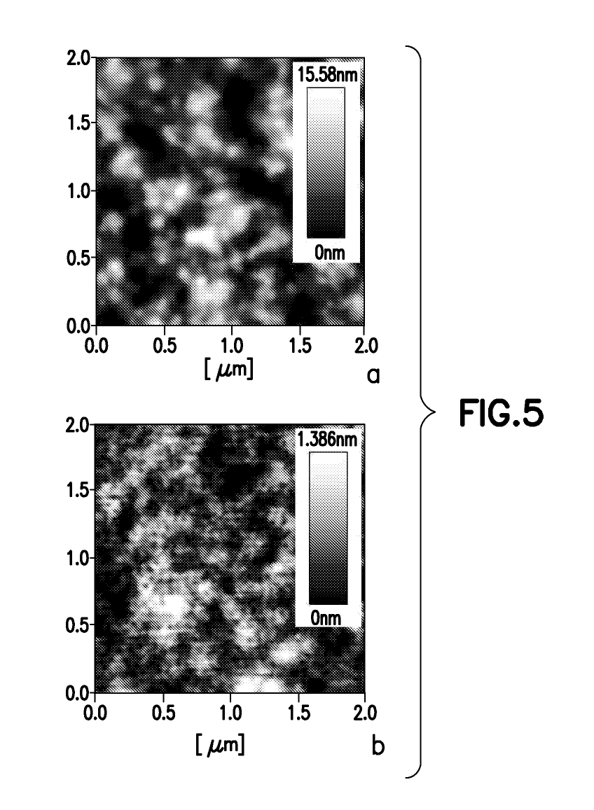

As stated previously, AFM is used to observe the variation in morphology of the PDMS stamps before and after implementation of the disclosed methods. As evident from the AFM images in FIGS. 5(a) and 5(b), it is clear that the P3HT film spun on PDMS surface reveals a chain-like feature that is assigned to the stack of P3HT chains with a root mean square roughness (RMS) of 7.8 nm (FIG. 5(a)). In contrast, the AFM image of the PDMS shows a much smoother morphology with an RMS of 1.1 nm (FIG. 5(b) after the stamping method is implemented. A smooth morphology is expected because PDMS stamps were molded on a Si wafer, and, hence follow the surface roughness of the Si wafer that is smooth. Consequently, based on the variation of the surface roughness, it is apparent that the polymer film can be completely transferred to the target surface without sustaining any damage.

In actuality, there is a significant amount of information that is provided by the results of the AFM. For example, Table 1 below shows the RMS roughness of P3HT:PCBM measured by AFM.

TABLE 1

| | Spin on | Spin on | PDMS after | Transferring |
|---|---|---|---|---|
| Surface | glass | PDMS | transferring | to glass |
| RMS(nm) | 0.818 | 3.54 | 0.315 | 1.619 |

As initially shown in Table 1, the film formed on PDMS stamps exhibit higher roughness values (see surface shown in FIG. 4(a)) in comparison to the values on glass (see FIG. 4(d)). Consequently, the successive layer transferred onto the PDMS stamp warrants providing a greater interface area in combination with the preceding layer. Secondly, the surface roughness of the film that is transferred to the glass substrate from the PDMS stamp (see FIG. 4(c)) is also higher than the surface that is fabricated using the conventional spin coating method, but slightly lower than the surface shown in FIG. 4(a), which may be due to the effect of thermal annealing that occurs during transferring. The foregoing is a strong indication that devices made by PDMS transferring methods may require higher performances than devices made by conventional spin coating methods, mainly because of larger interfaces and surface roughnesses that could be controlled by PDMS surface modification for the further enhancement of the device performance by higher interface area.

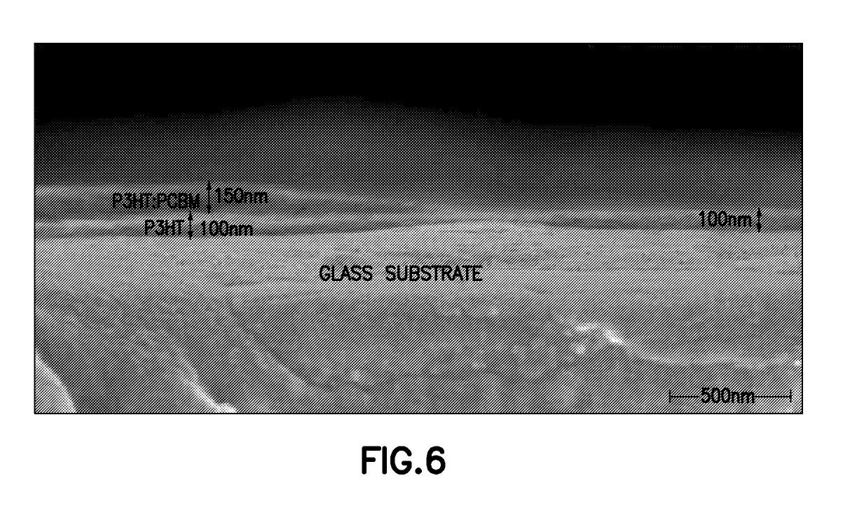

FIG. 6 is a cross-sectional illustration of the SEM image of glass substrate with P3HT disposed on its top and P3HT:PCBM (1:1) as the second layer (i.e., by PDMS transference and using chloroform as the solvent). The accomplishment of multilayer films via the PDMS transference method in accordance with the disclosed embodiments is also evidenced from Scanning Electron Microscopy (SEM) cross section images as shown in FIG. 6.

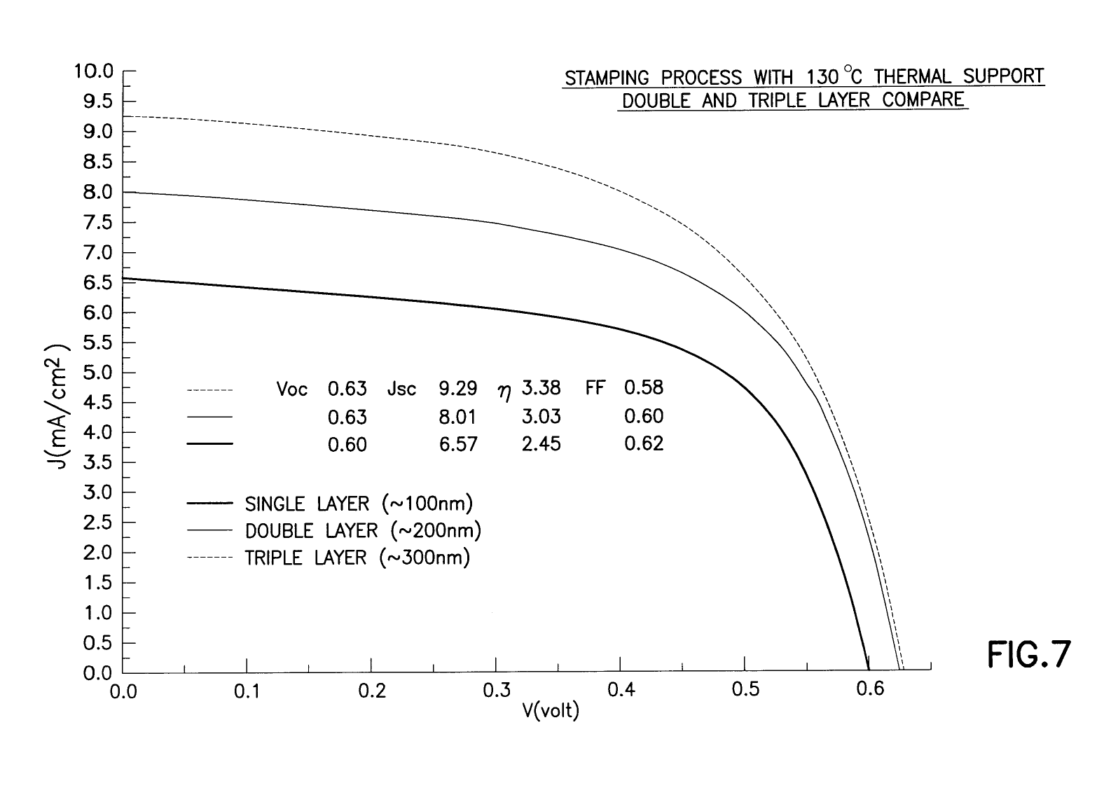

FIG. 7 provides a comparison of cell performance under AM 1.5G (100 mWcm⁻²) for single, double and triple active layers of P3HT:PCBM (1:1 in wt %) from chloroform made by the PDMS film in accordance with the embodiments of the disclosed methods. Here, the device structure comprises ITO/PEDOT:PSS(30 nm)/P3HT:PCBM for three different, distinct kinds of architectures/Ca(30 nm)/Al(70 nm). In accordance with the disclosed embodiments, the P3HT is transferred onto the glass substrate as the first layer and P3HT:PCBM heterojunction films are transferred on top of the first layer. The interface is then located, i.e., the left part as depicted in the inset and the border portion between one layer and the two layer region. Here, the bottom layer distinctly not only sustains its integrity and support for the top layer, without any mechanical misfit resulting from the transferring procedure, but the bottom layer also forms a compact contact top layer.

The inventors fabricated the commonly used polymer donor and fullerene acceptor system on a solar cell, i.e., P3HT and PCBM, in order to further validate the feasibility of applying the disclosed embodiments of the methods to emerging polymer electronics. It is known that thicker the active layer of a device, the more solar light that will be absorbed by the device. In view of the foregoing, the inventors constructed various multilayered devices using the above-described PDMS transference methods. For example, the inventors constructed single, double and triple layers having the same P3HT:PCBM constitution.

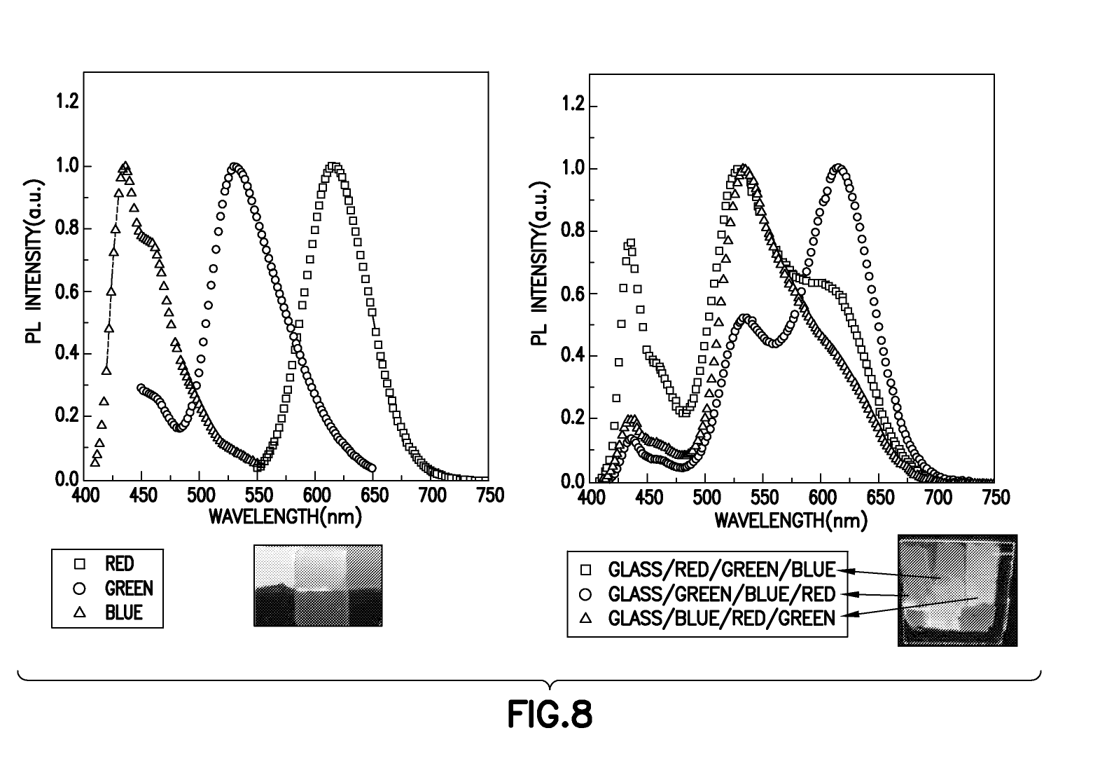

Thus, in accordance with validating that the properties of the transferred films maintained their photo-electrical characteristics, the inventors conveyed three general light emitting polymers, polyfluorene derivatives as Red (R), Green (G) and Blue (B). FIGS. 8(a) and 8(b) are graphical plots of normalized photoluminescence spectra of three polyfluorene derivatives excited at 400 nm, abbreviated as R, G, and B, where FIG. 8(a) is a graphical plot of the emission spectra for three pure materials and one triple layer comprised of R, and B, with the inset graph pictured by UV lamp, and FIG. 8(b) is a graphical plot of the absorbance and photoluminescence (PL) quenching results for P3HT, PCBM, single films and double film formed using the disclosed PDMS stamping methods.

The pure emission spectra of each material is shown in FIG. 8(a), where the inset picture shows three transferred films and one triple layer is illustrated by the other three plots. Here, it can be appreciated that the sequence of the R, G, B combination emits different light because of the light resulting from the UV lamps. Hence, the transparent nature of the top layer affects the absorbance of the bottom layer. In order to achieve white light emission, an adjustment is required of the relative thickness and sequence according to the photoluminescence intensities and transparency of each film. Here, the disclosed methods of multi-layer fabrication demonstrate that the transferred films have a specific uniformity and that they are capable of being color tuned. The PL result not only demonstrates the capability for color tuning and the film uniformity of the polymer light emitting films fabricated from the disclosed method but also provides a way to achieve a higher level of efficiency, as well as another effective way to achieve a white polymer light emitting diode (PLED).

In general, it is possible to obtain a white PLED by simply blending orange and blue light emitting polymers for a single emitting layer device. However, it is more difficult to control the morphology of a polymer blend system than one single polymer layer. The disclosed methods permit the easy fabrication of multi-layer PLED devices to fulfill the role of providing white light emission by confining the electron hole combination site to a specific location. Moreover, the method provides a way to control and provide the optimum morphology for each polymer in each single layer.

Table 2, for example, shows the cell performance of the three kinds of active layer architecture shown in FIGS. 8(a) and 8(b).

TABLE 2

| | V_{OC}(volt) | J_{SC}(mAcm⁻²) | FF | η |
|---|---|---|---|---|
| Single active layer | 0.60 | 6.57 | 0.62 | 2.45 |
| Double active layer | 0.63 | 8.01 | 0.60 | 3.03 |
| Triple active layer | 0.63 | 9.29 | 0.58 | 3.38 |

From the results provided in Table 2, it is readily apparent that a thicker active layer yields a larger photo current, because a greater fraction of solar light will be absorbed by those devices. Moreover, the effectiveness of such kinds of film formation for solar cells depends largely on the fill factor (FF) and open circuit voltage. It should be noted that there is a negligible change in FF and V_{OC} for the double and triple active layer devices when compared to the single layered devices, which indicates that the interface between each layer in the multilayer structure made from the disclosed transference methods have a very high level of compatibility with each other.

Alternatively, film integrity may be ensured by comparing the absorbance and PL intensity for a P3HT:PCBM double layer system. With specific reference to the graphical plot of FIG. 8(b), it can be appreciated that after the top PCBM film is transferred by the PDMS transference process to the preceding P3HT layer and onto the glass substrate, the absorbance of the bilayer films then appears. As a result, it becomes possible to ensure that the P3HT films will not become damaged during the PDMS transference process. Moreover, the PL intensity of a P3HT film becomes diminished after transference of the PCBM top layer onto the P3HT film. Consequently, it is apparent that the photo-electrical properties of exciton generation and electron hole transport phenomena are not affected during the transference.

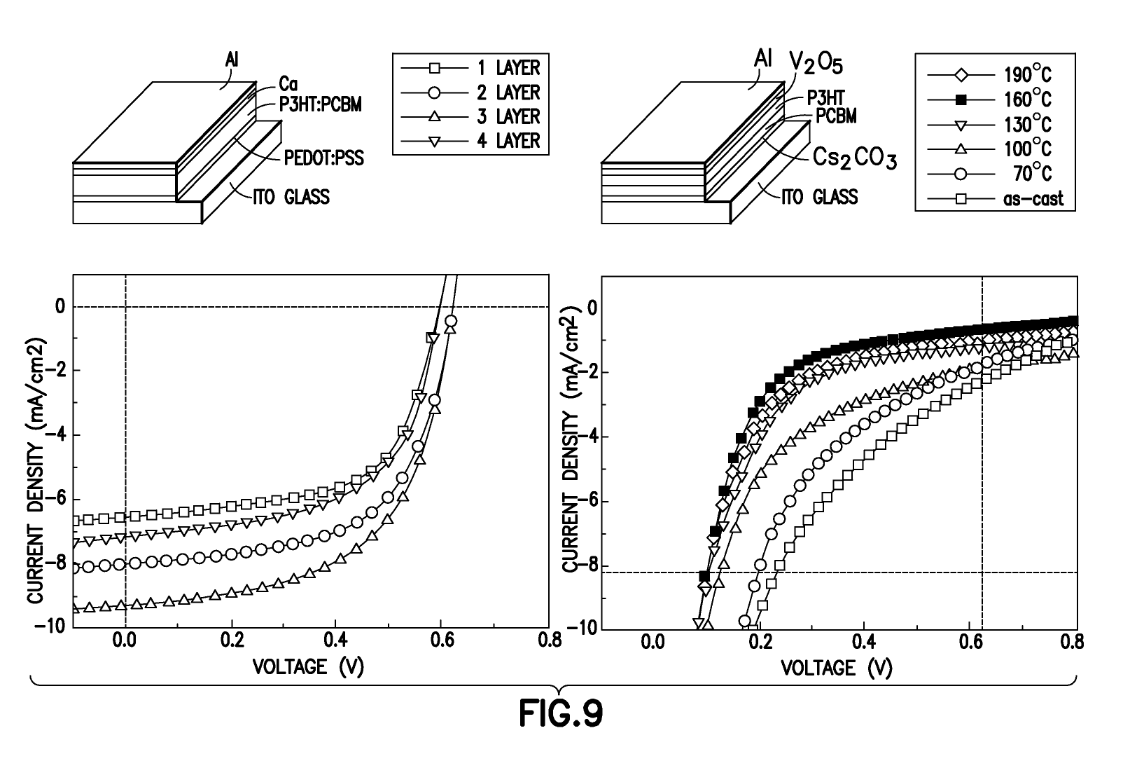

The present inventors examined the feasibility of implementing the disclosed methods for the fabrication of bi-layer and multilayer devices, in which the transference of a polymer layer onto another polymer layer is important and, hence, is validated by fabricating multilayer bulk heterojunction (BHJ) SCs. The P3HT:PCBM (1:1) layers were cast from chloroform and the thickness was controlled at 100 nm. Here, the total number of layers is varied from 1 to 4, and its dependence on the device performance is monitored. Samples were annealed at 130° C. after transferring each active layer to improve the interface between the different active layers. The duration of annealing was performed for a specific time-period, such as 5 minutes. Lastly, an approximately 30 and 100 nm thick Ca and Al was thermally evaporated. The structure of such a device structure is shown in FIG. 9(a). The short circuit current (J_{SC}) gradually increased from 6.89 mA/cm² for a single layer system (100 nm) to as high as 9.74 mA/cm² for a three layered systems (300 nm), and finally reduced to 7.52 mA/cm² (400 nm), as also shown in FIG. 9(a). The increase of the J_{SC} is accounted for by the larger fraction of solar light that is absorbed by devices having a thicker active layer. It should be noted that the absorbance is increased by a further increase of the thickness of the active layer. However, the J_{SC} will decrease to 7.52 mA/cm² for devices having four active layers. The decrease of the J_{SC} is due to the poor transport of photo-generated charges leading to a serious charge recombination. Triple layered devices exhibit a cell performance having an efficiency of ˜3.55%. It is notable that the fill factor (FF) of devices with 1 layer and 3 layers are 62.0 and 62.7%, and the corresponding open circuit voltage (V_{OC}) is 0.60 and 0.61 V, respectively. Such a similar FF and V_{OC} indicate that a quality interface can be formed between each layer using the method of the invention. Moreover, tandem polymer SCs and polymer LEDs can also be achieved via the disclosed method by incorporating connecting layers, such as silver nano-particles.

In an embodiment, a surface modified stamping method is implemented to fabricated inverted bi-layer SCs. A schematic representation of devices manufacture in accordance with the present embodiment is shown in the inset of FIG. 9(b). With specific reference to FIG. 9(b), shown is the performance of the inverted cells under various annealing temperatures. For a device without thermal annealing, after implementation of the contemplated methods, the power conversion efficiency (PCE) is 0.97%, as evidenced by reference to the AFM image shown in FIG. 5(a). Typically, the transferred P3HT film has a rough surface that causes a portion of the P3HT surface to not touch the underlying PCBM. In this case, voids will develop between the P3HT and PCBM thin films. Consequently, the device performance is poor. However, such a problem is easily resolved by implementing the annealing process described above. With an increase of the annealing temperature from room temperature to 160° C., all of the device characteristics, such as V_{OC}, J_{SC} and FF, were improved. The devices can be activated leading to an increase of PCE from 0.97 to 2.83%. Here, the optimal annealing temperature is within the range of 160-190° C., which is higher than the glass transition temperature of P3HT. This enhanced annealing temperature range is due to reorganization of the polymer and, therefore, a reduction of the voids is achieved and more interfaces are provided for exciton dissociation.

The inverted devices exhibit better performance than most small molecule bi-layer SCs made via thermal evaporation and exhibit better performance in comparison to devices made by other polymer transfer techniques. However, the efficiency of the devices manufactured in accordance with the present embodiment is slightly lower in comparison to P3HT:PCBM based BHJ SCs. Bi-layer structures can have higher hole and electron collection efficiency. However, fewer interfaces are provided for exciton dissociation in comparison to the BHJ SCs.

Table 3 provides a summary of all performance parameters for the BHJ and bi-layer devices, i.e., J_{SC}, V_{OC}, FF and PCE as a function of the number of active layers and annealing temperatures.

TABLE 3

| Sample | J_{SC}/mA cm⁻² | V_{OC}/V | FF (%) | PCE (%) |
|---|---|---|---|---|
| BHJ Device | | | | |
| 1 Layer | 6.90 | 0.61 | 62.0 | 2.56 |
| 2 Layer | 8.41 | 0.61 | 62.1 | 3.18 |
| 3 Layer | 9.75 | 0.61 | 62.7 | 3.55 |
| 4 Layer | 7.51 | 0.60 | 58.6 | 2.64 |
| Bi Layer Device | | | | |
| As-cast | 6.43 | 0.44 | 34.2 | 0.97 |
| 70° C. | 6.96 | 0.48 | 39.8 | 1.33 |
| 100° C. | 6.87 | 0.56 | 48.1 | 1.85 |
| 130° C. | 7.62 | 0.58 | 55.9 | 2.47 |
| 160° C. | 8.18 | 0.58 | 59.6 | 2.83 |
| 190° C. | 7.79 | 0.58 | 57.7 | 2.61 |

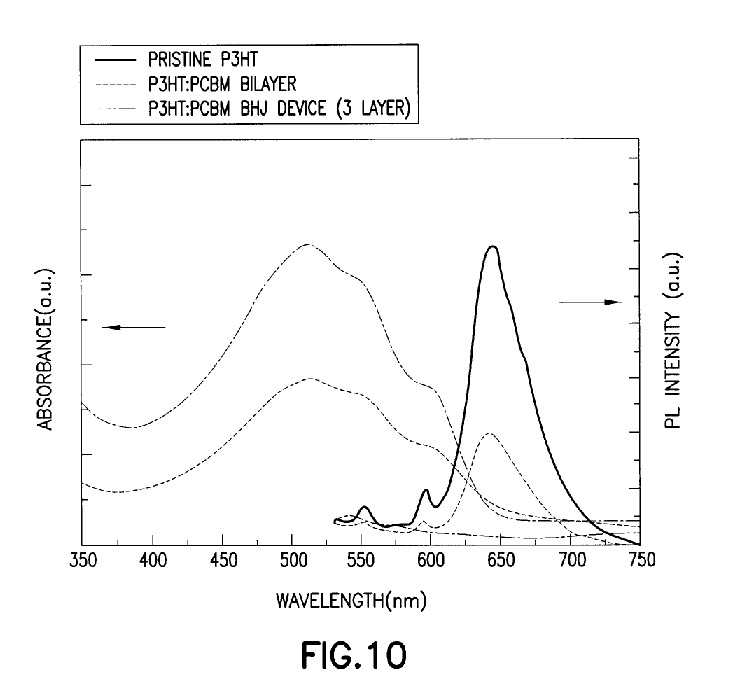

From the graphical plot of photoluminescence (PL) spectra shown in FIG. 10, it is apparent that excitons are not entirely eliminated (i.e., quenched) in the bi-layer SC structure, but in the BHJ structure the quenching is more efficient. In addition, the absorption of bi-layer SCs is also smaller than the absorption of BHJ SCs. Optimization of the P3HT and PCBM thickness can improve the quenched capability and absorption of P3HT:PCBM bilayer SCs, resulting in a further improved device efficiency.

The disclosed film transferring method thus permits the easy construction of multilayer polymer electronics having high quality interfaces. Based on the results obtained by SEM, AFM and intrinsic film properties of absorbance and photoluminescence, it is apparent the inventors' disclosed methods thus provide an advantageous way to fabricate multilayer polymer electronics. Moreover, the disclosed methods provide an optimum cell that demonstrates the effectiveness of the disclosed film transference methods. The disclosed methods thus pave the way to develop higher performing devices and provide a route for extending the study of device physics for future organic electronics.

In accordance with the disclosed embodiments, polymer-polymer and polymer-small molecule interfaces are successfully achieved using the disclosed PDMS stamping method without destroying the preceding layers. The present inventions have performed electrical and optical studies that permit the inference that the disclosed method can easily fabricate multilayer organic optoelectronic devices. By combining the disclosed method with careful design of the device structure and matching materials with suitable properties, the disclosed PDMS transfers permit the fabrication of tandem or cascade polymer LEDs and polymer SCs having an improved level of performance.

Thus, while there are shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for fabricating at least a component of an organic optoelectronics device, comprising:
treating a surface of a polydimethylsiloxane (PDMS) stamp with at least one organic solvent;
spin-coating a first polymer film onto the surface of the PDMS stamp to coat the first polymer film onto the surface; and
transferring the first polymer film from the PDMS stamp to a target surface.

2. The method of claim 1, wherein one of the at least one organic solvent cleans the PDMS surface and eliminates stress on the PDMS surface.

3. The method of claim 1, wherein the at least one solvent comprises acetone, toluene or cholorobenzene.

4. The method of claim 1, wherein the residual vapor pressure of the organic solvent at the surface of the PDMS stamp is maintained at a predetermined level.

5. The method of claim 1, wherein said transferring step comprises applying an external force to create a conformal contact between the first polymer film and the target surface.

6. The method of claim 5, wherein the transferring step is conducted at substantially the glass transition temperature of the first polymer film.

7. The method claim 1, wherein the target surface is polyethylene terephtalate (PET) or indium tin oxide, uncoated or coated with a layer of poly(ethylene dioxythiophene):polystyrenesulfonate or caesium carbonate.

8. The method claim 1, wherein after transferring the first polymer film from the PDMS stamp to the target surface, the PDMS stamp is reusable for successive spin-coating of polymer film and film transfers.

9. The method of claim 8, wherein the PDMS stamp is reused to transfer a second polymer film onto the first polymer film.

10. The method of claim 1, wherein the first polymer film is poly(3-hexylthiophene), or a blend of poly(3-hexylthiophene) and [6,6]-phenyl C61-butyric acid methyl ester.

11. The method of claim 9, wherein the first polymer film is poly(3-hexylthiophene), and the second polymer film is [6,6]-phenyl C61-butyric acid methyl ester.

12. The method of claim 11, further comprising the step of annealing the first and second polymer films.
